(19) United States
(12) Patent Application Publication
(10) Pub. No.: US 2025/0393030 A1
(43) Pub. Date: Dec. 25, 2025

(54) SYSTEM AND METHOD FOR EFFICIENT RE-(DE)MAPPER DESIGN IN HETEROGENEOUS COMPUTING SYSTEM

(71) Applicant: JIO PLATFORMS LIMITED, Ahmedabad (IN)

(72) Inventors: Vinod Kumar SINGH, Navi Mumbai (IN); Veera Sai Satyanarayanna Prasad MARNI, Navi Mumbai (IN); Hiren PATEL, Navi Mumbai (IN); Kumar Vishal RAI, Punjab (IN); Aayush BHATNAGAR, Navi Mumbai (IN); Pradeep Kumar BHATNAGAR, Navi Mumbai (IN)

(73) Assignee: JIO PLATFORMS LIMITED, Ahmedabad (IN)

(21) Appl. No.: 18/879,951

(22) PCT Filed: Aug. 25, 2023
(86) PCT No.: PCT/IB2023/058427

§ 371 Date: Dec. 30, 2024

(30) Foreign Application Priority Data
Aug. 30, 2022 (IN) 202221049589

(51) Int. Cl. H04W 72/04

(52) U.S. Cl. CPC H04W 72/04

(57) ABSTRACT

The present disclosure provides a system and a method for controlling overhead and functional split of a Resource Element (RE) mapper in a heterogeneous system. The system may receive physical channel Protocol Data Units (PDUs) including one or more parameters. The system may pre-process the one or more parameters of the physical channel PDUs. and generate one or more bits of control information per Physical Resource Block (PRB) based on the pre-processed one or more parameters. The system may arrange the generated one or more bits of control information per PRB in a grid, and transfer the grid including the generated one or more bits of control information per PRB from a processing system to a programmable logic of the heterogeneous system using a Direct Memory Access (DMA). The RE mapper in programmable logic space uses control grid to arrange/map data of various physical channels for over the air transmission.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The present disclosure relates generally to wireless telecommunication technology, and more particularly to a system and a method for controlling overhead and functional split of a Resource Element (RE) mapper in a heterogeneous computing system.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

A physical layer (L1) of a base station in a wireless communication technology defined by a 3rd Generation Partnership Project (3GPP) like 4^{th} Generation (4G) Long-Term Evolution (LTE) or 5^{th} Generation (5G) New Radio (NR) may deal with parsing and processing of L1 parameters received from a Medium Access Control (MAC) to a physical (PHY) interface like functional application platform interface (FAPI) as illustrated in FIG. 1A. The processed L1 parameters generate required block-specific huge control information, and its implementation over a Programmable Logic (PL) adds to excess in processing time and resources.

In all the blocks defined by 3GPP, the complex block which requires huge control information is a Resource Element (RE) Mapper in downlink or De-Mapper in uplink. In addition, this block may also be computationally intensive in (de) mapping all the channel data onto/from a slot grid.

Referring to representation 100A of FIG. 1A, the physical layer (106) may receive various messages or packets from Layer 2 (L2) (102) and/or Layer 3 (L3) on a per-slot basis over the MAC to PHY interface like FAPI (104). Further, the physical layer (106) may receive messages from hardware engines and peripherals (112). Then, the physical layer (106) may process the packets and send the packets to a Radio Frequency (RF) front-end module (108) for over-the-air (OTA) transmission (110).

In downlink, the messages received from L2 for different chains, may include payload and corresponding L1 parameters specifying the allocation details. The allocation details may be used for mapping onto a slot grid meant for transmission. Every slot, therefore, consists of multiple downlink channels catering to various User Equipments' (UEs) Protocol Data Units (PDUs) and cell broadcast messages. The implementation of 5G NR physical layer on any processor may need to take care of the following:
1) Reception and parsing of slot messages as well as slot configuration from L2.
2) Pre-processing of L1 parameter information received from L2.
3) Processing of each channel data information received from L2.
4) Resource element (RE) Mapping:
   a. Processing of control information to design a grid.
   b. Mapping of processed data onto the slot grid using the above-processed control information.
   c. Transmission of the slot grid to the radio unit for on-air transmission.

Tasks 1 and 2 mentioned above may be completed in slot N−2, task 3 in slot N−1, and task 4 in slot N, each with a time constraint of 500 us (while considering subcarrier spacing of 30 kHz), where N is the on-air transmission slot number as shown in representation 100B of FIG. 1B. In a heterogeneous computing system with a Processing System (PS) and the PL, the PS may host tasks 1 and 2 and remaining tasks 3 and 4 may be handled in the PL.

However, in this approach, even though the control configuration is available in slot N−1, but still a Resource Element (RE) mapper may consume the control configuration in slot N, because the RE mapper needs to wait for the data processing of all other downlink physical chains to complete. Hence, the PS is underutilized. This implementation of RE mapper also requires processing of control parameters of each channel to map its processed data onto slot grid, thereafter, increasing RE mapper design complexity, especially in a heterogeneous platform where control parameter processing will require additional PL resources and processing time.

Hence, there is a requirement in the art for an efficient way of handling such a complex block design and reducing the usage of PL resources and processing cycles.

### OBJECTS OF THE PRESENT DISCLOSURE

Some of the objects of the present disclosure, which at least one embodiment herein satisfies are listed herein below.

It is an object of the present disclosure to provide a system and a method for handling complex resource element (RE) mapping block by processing split and performing handshake between a processing system and a programmable logic in an efficient manner, thus reducing the usage of programmable logic resources and processing cycles.

It is an object of the present disclosure to facilitate an efficient utilization of a plurality of processing systems and programmable logic resources.

It is an object of the present disclosure to reduce Direct Memory Access (DMA) transfer time and memory with Physical Resource Block (PRB) wise design.

It is an object of the present disclosure to reduce programmable logic resources and processing latency of a Resource Element (RE) mapper.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for controlling overhead and functional split of a Resource Element (RE) mapper. The system includes one or more processors and a memory operatively coupled to the one or more processors. The memory includes processor-executable instructions, which on execution, cause the one or more processors to receive a plurality of physical channel Protocol Data Units (PDUs) including one or more parameters, pre-process the one or more parameters of the plurality of physical channel PDUs, generate one or more bits of control information per Physical Resource Block (PRB) based on the pre-processed one or more parameters, arrange the generated one or more bits of control information per PRB in a grid, and transfer the grid including the generated one or more bits of control information per PRB from a processing system to a programmable logic of the system using a Direct Memory Access (DMA).

In an embodiment, the one or more parameters of the plurality of physical channel PDUs may include at least one of the mapping parameters such as start PRB, number of PRBs, start symbol, and number of symbols, and other mapping parameters such as a Demodulation Reference Signal (DMRS) type, a number of layers, a Code-Division Multiplexing (CDM) type. The plurality of physical channel PDUs may include at least one of the Synchronization Signal Block (SSB), Physical Downlink Control Channel (PDCCH), Physical Downlink Shared Channel (PDSCH), and Channel State Information Reference Signal (CSI-RS).

In an embodiment, the one or more processors may arrange the generated one or more bits of control information per PRB in the grid by being configured to process the generated one or more bits of control information per PRB and form the grid based on the generated one or more bits of control information per PRB.

In an embodiment, a bit width of the one or more bits of control information may be variable, where the bit width may be 16.

In an embodiment, the one or more processors may transfer the grid to the programmable logic using an Advanced Extensible Interface Code-Division Multiple Access (AXI-CDMA).

In an aspect, the present disclosure relates to a method for controlling overhead and functional split of a Resource Element (RE) mapper. The method includes receiving, by a processor associated with a system, a plurality of physical channel Protocol Data Units (PDUs) including one or more parameters, pre-processing, by the processor, the one or more parameters of the plurality of physical channel PDUs, generating, by the processor, one or more bits of control information per Physical Resource Block (PRB) based on the pre-processed one or more parameters, arranging, by the processor, the generated one or more bits of control information per PRB in a grid, and transferring, by the processor, the grid including the generated one or more bits of control information per PRB from a processing system to a programmable logic of the system using a Direct Memory Access (DMA).

In an embodiment, the one or more parameters of the plurality of physical channel PDUs may include at least one of the mapping parameters such as start PRB, number of PRBs, start symbol and number of symbols, and other mapping parameters like a Demodulation Reference Signal (DMRS) type, a number of layers, a Code-Division Multiplexing (CDM) type. The plurality of physical channel PDUs may include at least one of the Synchronization Signal Block (SSB), Physical Downlink Control Channel (PDCCH), Physical Downlink Shared Channel (PDSCH), and Channel State Information Reference Signal (CSI-RS).

In an embodiment, arranging, by the processor, the generated one or more bits of control information per PRB in the grid may include processing, by the processor, the generated one or more bits of control information per PRB and forming, by the processor, the grid based on the generated one or more bits of control information per PRB.

In an embodiment, a bit width of the one or more bits of control information may be variable, where the bit width may be 16.

In an embodiment, transferring may include transferring, by the processor, the grid to the programmable logic using an Advanced Extensible Interface Code-Division Multiple Access (AXI-CDMA).

In an aspect, the present disclosure relates to a non-transitory computer-readable medium including processor-executable instructions that cause a processor to receive a plurality of physical channel Protocol Data Units (PDUs) including one or more parameters, pre-process the one or more parameters of the plurality of physical channel PDUs, generate one or more bits of control information per Physical Resource Block (PRB) based on the pre-processed one or more parameters, arrange the generated one or more bits of control information per PRB in a grid, and transfer the grid including the generated one or more bits of control information per PRB from a processing system to a programmable logic of the system using a Direct Memory Access (DMA).

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1A illustrates an exemplary architecture (100A) of a high-level base station.

FIG. 1B illustrates an exemplary downlink slot processing timing diagram (100B).

FIGS. 2A-21 illustrate exemplary representations (200A-2001) of mapping of few downlink channels data onto slot grid associated with the base station.

FIG. 3 illustrates an exemplary network architecture (300) in which or with which a system (308) of the present disclosure may be implemented, in accordance with an embodiment of the present disclosure.

FIG. 4 illustrates an exemplary block diagram (400) of the proposed system (308), in accordance with an embodiment of the present disclosure.

FIG. 5A illustrates an exemplary architecture (500A) of a radio frequency system on chip (RFSoC), in accordance with an embodiment of the present disclosure.

FIG. 5B illustrates an exemplary representation (500B) of a Resource Element (RE) mapper for implementing control parameter buffer transfer mechanism from a processing system (PS) to a programmable logic (PL) in a heterogeneous computing system, in accordance with an embodiment of the present disclosure.

FIG. 6A illustrates an exemplary representation (600A) of an RE mapper control parameters buffer or grid, in accordance with embodiment of the present disclosure.

FIG. 6B illustrates an exemplary representation (600B) of data channel parameter bit map, in accordance with an embodiment of the present disclosure.

FIG. 7 illustrates an exemplary computer system (700) in which or with which embodiments of the present invention may be utilized in accordance with embodiments of the present disclosure.

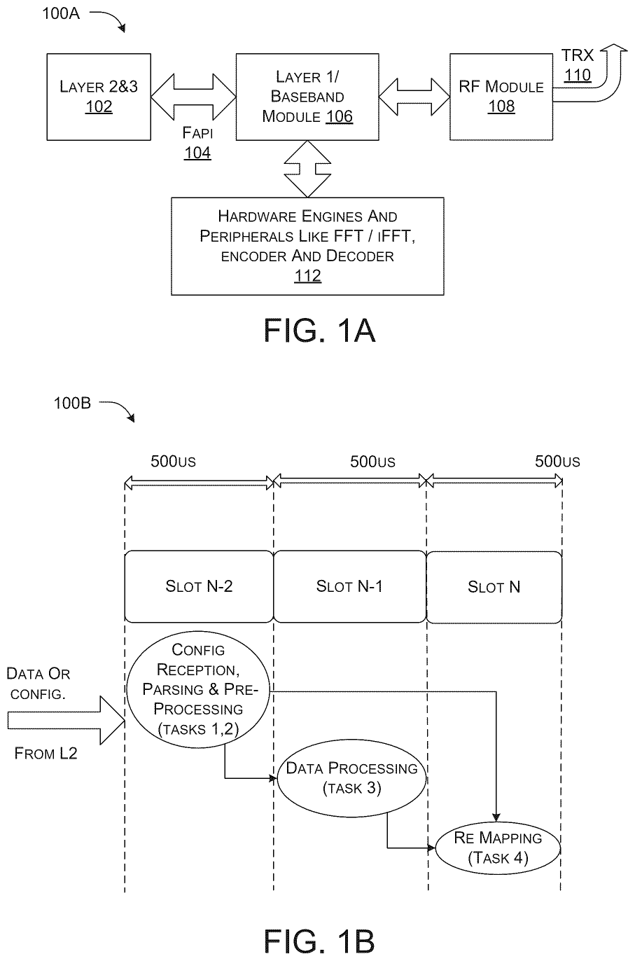

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

A person skilled in the art may be aware that a 3^{rd} Generation Partnership Project (3GPP) specification provides technical details behind 5G New Radio (NR), successor of a Long-Term Evolution (LTE). In the LTE, there is only one type of numerology or subcarrier spacing (15 kHz), whereas in NR, multiple types of subcarriers spacing are available. For example, 5G NR supports subcarrier spacing of 15, 30, 60, 120, and 240 KHz. 5G NR covers a very wide range of frequencies (e.g., sub 3 GHZ, sub 6 GHz, and mm-Wave over 25 GHZ) and each frequency range has its own characteristics in terms of propagation, doppler, inter-symbol interference, etc. In order to achieve maximum efficiency or performance, multiple subcarrier options are used.

In 5G NR, the base station consists of various downlink physical channels and uplink physical channels as defined by 3GPP standards. In the downlink physical channels, there are Synchronization Signal Block (SSB) (which includes Primary Synchronization Signal (PSS), Secondary Synchronization Signal (SSS), and Physical Broadcast Channel (PBCH)), Physical Downlink Control Channel (PDCCH), Physical Data Shared Channel (PDSCH), and Channel State Information Reference Signal (CSIRS) channels. In the uplink physical channels, there is Physical Random-Access Channel (PRACH), Physical Uplink Shared Channel (PUSCH), Physical Uplink Control Channel (PUCCH), and Sounding Reference Signal (SRS) channels. 3GPP-defined mapping process of the downlink physical channels and the uplink physical channels are described in following briefs:

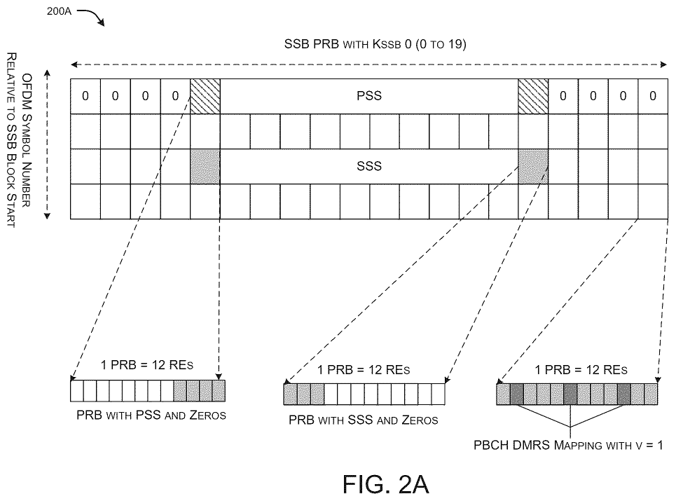

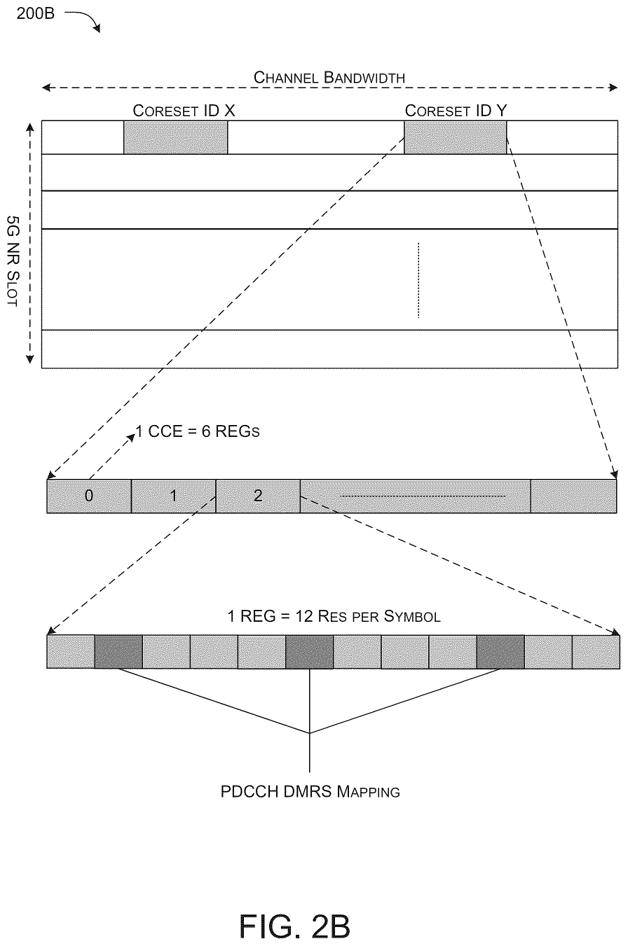

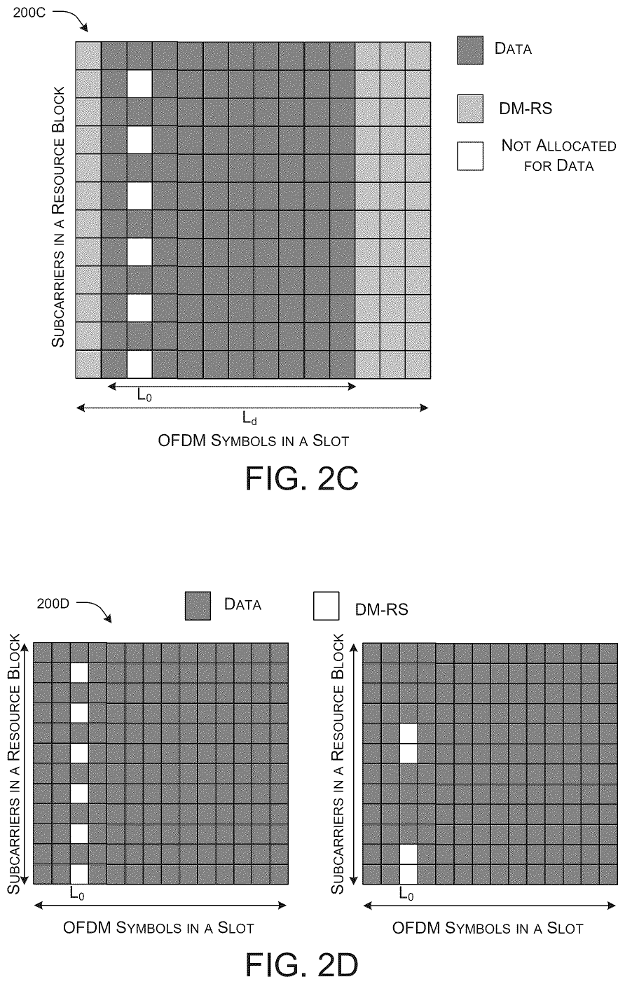

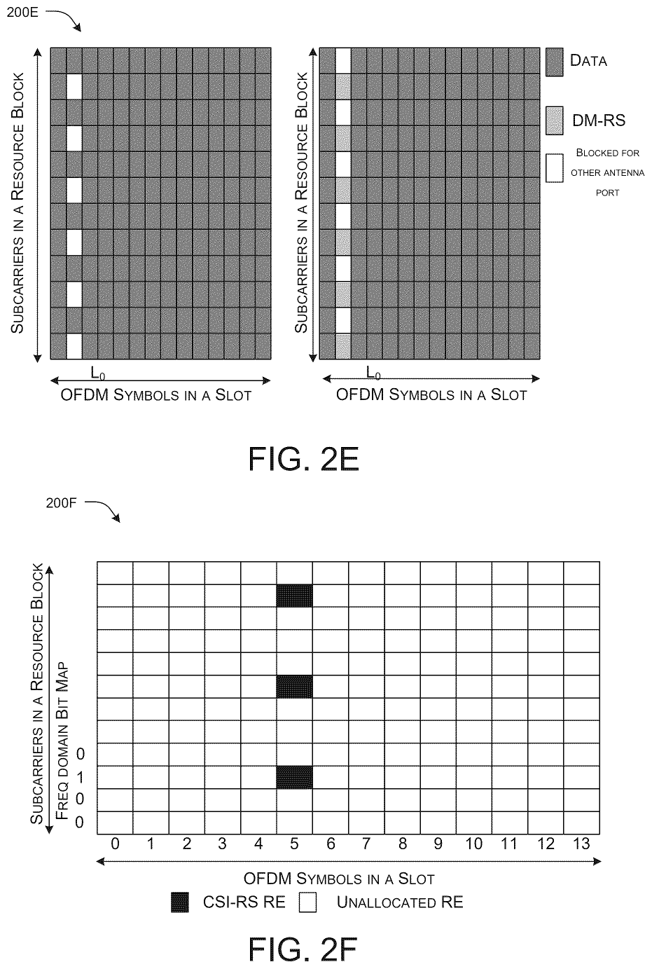

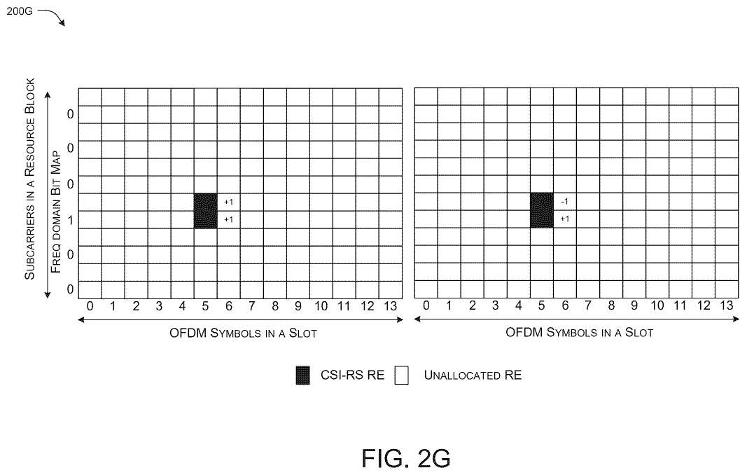

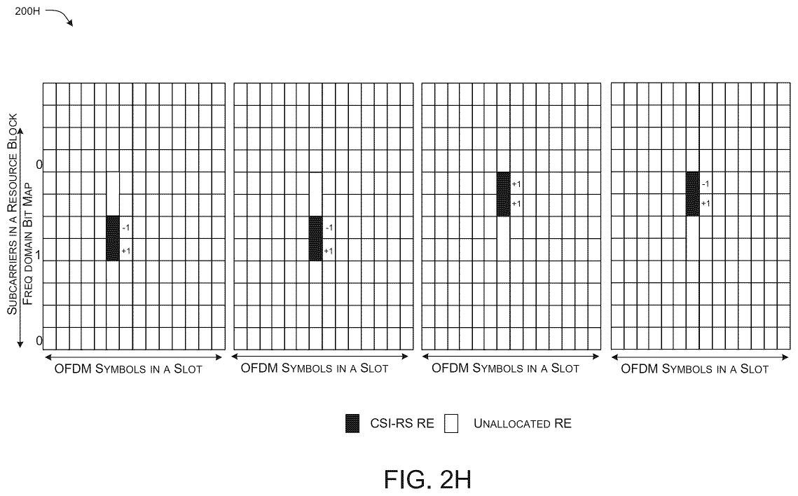

Synchronization Signal Block (SSB): The SSB contains the PSS channel, the SSS channel, and the PBCH channel, as illustrated in FIG. 2A. The SSB occupies 4 continuous time domain symbols, and 20 or 21 PRBs in each symbol. There may be 1, 2, or no SSB in a slot and number of occupied PRBs for SSB is 21 when the subcarrier offset is not a multiple of PRB number, otherwise it is 20. As shown in the representation 200A of FIG. 2A, the PSS channel is in a first symbol along with zeros above and below it. A second symbol and a fourth symbol contain the PBCH and PBCH-Demodulation Reference Signal (PBCH-DMRS), and the PBCH-DMRS is mapped to three subcarriers of the PRB whose indexes are 0+v. 4+v. 8+v, respectively. Here, offset v is given by Physical Cell ID (nCellID) mod 4. In a third symbol, first and last 4 PRBs have the PBCH along with the DMRS. In between the first and the last 4 PRBs, 127 subcarriers are mapped with SSS with zero padding of 8 subcarriers below and 9 subcarriers above it.

Physical Downlink Control Channel (PDCCH): The PDCCH carries downlink control information and is present in an interleaved or a continuous pattern in a Control Resource Set (CORESET) region of a slot grid. The PDCCH is confined to a single CORESET and is transmitted with its own DMRS. The PDCCH is transported by 1/2/4/8/16 control channel elements (CCEs) to accommodate different Data Communication Interface (DCI) payload sizes or coding rates. The CCEs consist of about 6 REGs each. Mapping for the CCE to the REG may be interleaved or non-interleaved. Number of bits to be transmitted on the PDCCH is scrambled before a modulation block. After scrambling, Quadrature Phase Shift Keying (QPSK) modulation is applied which results in complex modulated symbols. Next, the complex modulated symbols are mapped to physical resources with appropriate antenna port (p=2000) taking into consideration the DMRS mapping. The PDCCH-DMRS occupy fixed places in the PDCCH PRB i.e., 2nd, 6th, and 10th positions among the 12 subcarriers of one PRB, as shown in FIG. 2B.

Physical Downlink Shared Channel (PDSCH): The PDSCH carries downlink user-specific data. User Equipment (UE)-specific upper layer information, and broadcast messages such as system information and paging. The resources allocated for the PDSCH are within a bandwidth part (BWP) of the carrier. A symbol allocation of the PDSCH indicates Orthogonal Frequency Division Multiplexing (OFDM) symbol locations used by the PDSCH transmission in a slot. Start PRB, symbol, and number of PRB symbol define the mapping of the PDSCH. Frequency domain allocation may also be set as per a bit map. The PDSCH DMRS is present in each RB allocated for the PDSCH on specific symbols amongst its allocated symbols.

The frequency and time allocation of PDSCH DMRS are controlled by parameters including, but not limited to, PDSCH symbol allocation, mapping type, DMRS type A position, DMRS length, DMRS additional position, DMRS configuration type, and DMRS antenna ports. FIGS. 2C-21 depict few examples to illustrate usage of various parameters such as Mapping Type A, lo=2, PDSCH allocation Id=1 to 10 (0-based), as shown in FIG. 2C that highlights DMRS symbol location. FIG. 2D shows the examples of DMRS allocation based on configuration type by defining Mapping Type A. lo=2, PDSCH allocation=0 to 13, and configuration Type 0 and 1. FIG. 2E illustrates examples of DMRS allocation based on transmit antenna port by defining Mapping Type A, lo=2, PDSCH allocation=0 to 13, configuration Type 0, and single and multi-antenna port transmission.

Channel State Information Reference Signal (CSIRS): CSIRS is used in downlink for radio channel characteristics measurement. UE uses this channel to measure the channel information such as, for example, but not limited to, Reference-Signal-Receive-Power (RSRP), Reference Signal Received Quality (RSRQ), signal-to-interference-plus-noise ratio (SINR), Rank Indicator (RI), Lawful Interception (LI), etc., and report it back to a network. CSIRS is a DMRS sequence which is generated and mapped onto slot grid using parameters slot number, start PRB, number of PRBs, CSI type, row value, frequency domain parameter, SymbL0, SymbL1, CDM type, frequency density, and scrambling ID.

The frequency domain parameter of CSI-RS PDU is a bit map which defines the allocated subcarrier indexes within a PRB. Few example, scenarios are illustrated below for CSI-RS mapping:

CSI reference signals based on Row 1 may be given as Row-1, Frequency-Domain-0010, symbL0=5, Density=3, and the mapping of CSIRS REs in one PRB is as shown in FIG. 2F. CSI reference signals based on Row 3 may be given as Row-3, Frequency-Domain-001000, symbL0=5, Density=1, and the mapping of CSIRS REs in one PRB is as shown in FIG. 2G. CSI reference signals based on Row 3 may be given as Row-4, Frequency-Domain-010, symbL0=5, Density=1, and the mapping of CSIRS REs in one PRB is as shown in FIG. 2H.

Resource element (RE) Mapper: In 5G, radio resources are divided into time and frequency resource elements. Resource elements in time axis are divided into number of OFDM symbols and in frequency axis are divided into number of sub-carriers. RE is a smallest resource unit, which occupies a single sub-carrier and an OFDM symbol. 12 Res may be called a PRB (Physical Resource Block). A typical snippet from downlink frames containing various physical channels mapped onto slot grid is discussed with below configuration:
BWP Start and Size as 0 and 273, normal CP and subcarrier spacing as 1 (30 kHz).
PDSCH—PRB 0 to 272, Symbol 1 to 7, Dmrs configuration as follows: Mapping type-A, symbol-2, config type-0, numLayers-1, numCDMgrpNoData-1. Ports-1000
PDCCH—PRB 0 to 269, Symbol 0, CceRegMapping-0, Coresct-1, DCI configuration as follows:
One DCI having aggregation level-2, CceIndex-0.
SSB—Block occupies 8th to 11th symbol, SsbOffsetPointA-0, ssbSubcarrierOffset-0
CSIRS—PRB 0 to 271, Symbol-13, CSItype-1, Row-1, frequencyDomain-0010

The mapping of above channels is shown in FIG. 2I with only bottom 25 PRBs shown out of total 273 PRBs. The standard interface where above mentioned configuration exchange happens between L1 and L2 is through a FAPI interface. The downlink and uplink Transmission Time Interval (TTI) messages are sent from Layer 2 to Layer 1 through FAPI interface/standard per TTI. The PDUs received from L2 consists of allocation parameters and channel data. Various downlink physical channels are PDSCH, PDCCH, DMRS (PDSCH and PDCCH), CSIRS, SSB (PSS, SSS, and PBCH). These payloads of each channel are processed as per steps defined in 3GPP standard and as explained above, the mapping of the processed data onto slot grid is done, and subsequently, slot grid is passed on to radio unit for on-air transmission.

In an aspect, the present disclosure further provides for a system for controlling overhead and functional split of a Resource Element (RE) mapper. The system processes control information to define a grid and transfer the grid to a processing system (PS) to utilize the waiting time of Slot N−1. Further, the PS utilizes this grid to map the individual channel processed data onto the slot grid.

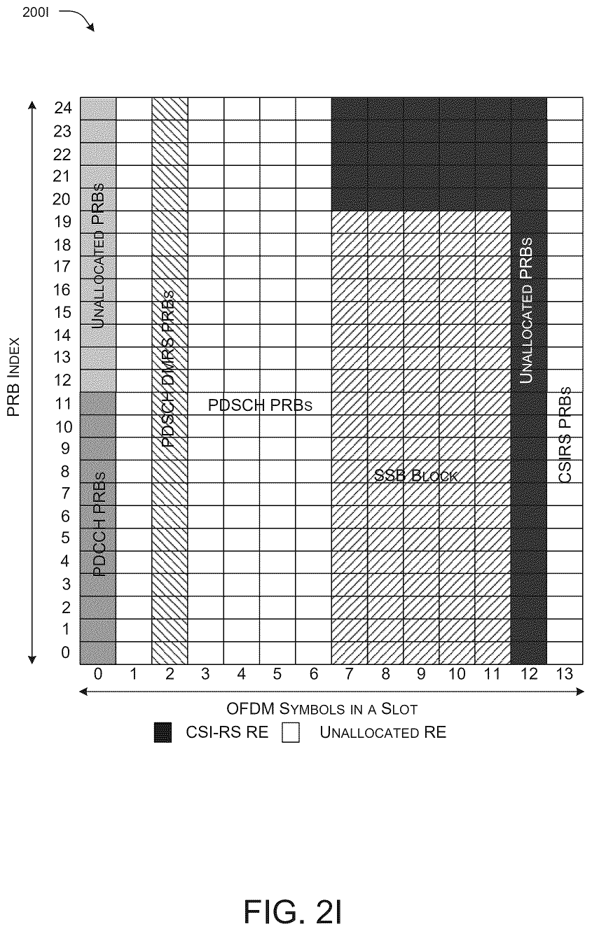

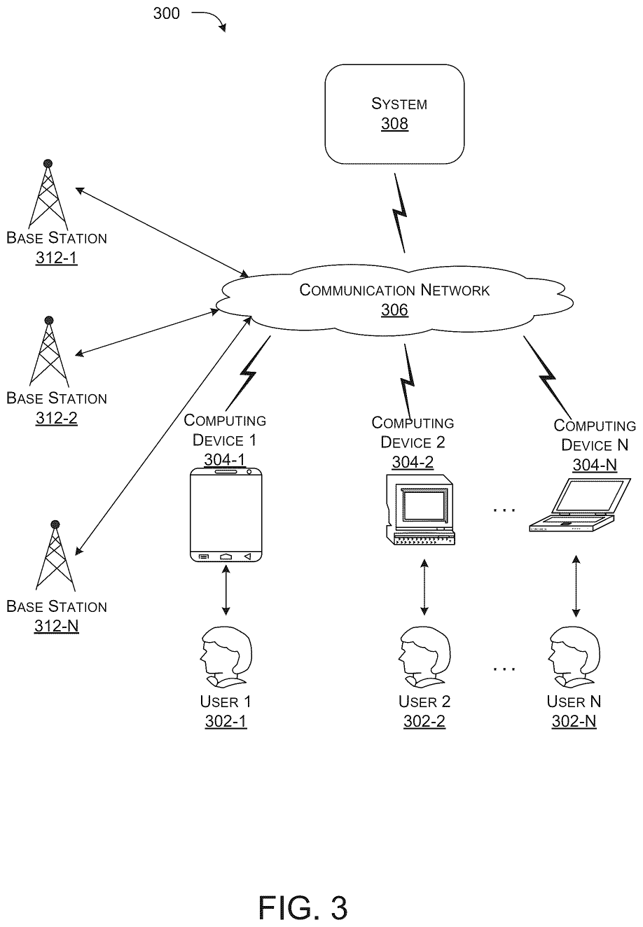

Referring to FIG. 3 that illustrates an exemplary network architecture (300) in which or with which a system (308) of the present disclosure may be implemented, in accordance with an embodiment of the present disclosure. As illustrated, the exemplary architecture (300) may include a plurality of base stations (312-1, 312-2 . . . 312-N) (individually referred to as the base station (312) and collectively referred to as the base stations (312)) and a plurality of users (302-1, 302-2 . . . 302-N) (individually referred to as the user (302) and collectively referred to as the users (302)) associated with one or more first computing devices (304-1, 304-2 . . . 304-N) (individually referred to as the first computing device (304) or user equipment (UE) (304) and collectively referred to as the first computing devices (304) or user equipments (UE) (304)).

The base station (312) may be a cellular base station, where antennas and electronic communications equipment may be placed typically on a radio mast, tower, or other raised structure to create a cell (or adjacent cells) in a cellular network.

As illustrated, the exemplary architecture (300) may be equipped with the system (308) for controlling overhead and functional split of a resource element (RE) mapper. The system (308) may be, for example, a heterogenous computing system such as a Field Programmable Gate Array (FPGA) platform but not limited to the like. Further, the system (308) may also be communicatively coupled to the one or more first computing devices (304) via a communication network (306).

The first computing device (304) (also interchangeably referred to as a user equipment or UE or terminal (304)) may be at least one of a wireline device or wireless device. For example, the wireline device may be a landline phone, a terminal device, or any other stationary device through which communication may be established. The wireless device may be a mobile device that may include, for example, a cellular telephone, such as a feature phone or smartphone and other devices. The computing device (304) may not be limited to the above-mentioned devices but may include any type of device capable of wireline or wireless communication, such as a cellular phone, a tablet computer, a personal digital assistant (PDA), a personal computer (PC), a laptop computer, a media centre, a work station and other such devices. In an embodiment, the computing device (304) may be at least one of a wireless or wireline device that may be subscribed or registered to the network (306). In an example embodiment, the network (306) may pertain to a fifth generation (5G) network, wherein a service provider may provide the network service corresponding to at least one of a cellular network service, a private network service, a satellite network service or a convergence network service.

In an example embodiment, the communication network (306) may pertain to, for example, a fifth-generation (5G) network service or a sixth-generation (6G) network service. In an embodiment, the communication network (306) may include at least one of a wireless network, a wired network, or a combination thereof. The communication network (306) may be implemented as one of different types of networks, such as Intranet, Local Area Network (LAN), Wide Area Network (WAN), Internet, and the like. Further, the communication network (306) may either be a dedicated network or a shared network. The shared network may represent an association of the different types of networks that use a variety of protocols, for example, Hypertext Transfer Protocol (HTTP), Transmission Control Protocol/Internet Protocol (TCP/IP), Wireless Application Protocol (WAP), Automatic repeat request (ARQ), and the like.

In an embodiment, the communication network (306) may pertain to a 5G network that may be facilitated through, for example, a Global System for Mobile communication (GSM) network; a universal terrestrial radio network (UTRAN), an Enhanced Data rates for GSM Evolution (EDGE) radio access network (GERAN), an evolved universal terrestrial radio access network (E-UTRAN), a Wireless-Fidelity (Wi-Fi) or other local area network (LAN) access network, or a satellite or terrestrial wide-area access network such as a wireless microwave access (WIMAX) network.

In an example embodiment, the communication network (306) may enable the 5G network based on subscription pertaining to the user (302)/computing device (304) and/or through a Subscriber Identity Module (SIM) card. Various other types of communication network or service may be possible.

In an example embodiment, the communication network (306) may utilize a different sort of an air interface, such as a Code Division Multiple Access (CDMA), Time Division Multiple Access (TDMA), or Frequency Division Multiple Access (FDMA) air interface and other implementations. In an example embodiment, a wireless user device may use wired access networks, exclusively or in combination with wireless access networks, for example, including Plain Old Telephone Service (POTS), Public Switched Telephone Network (PSTN), Asynchronous Transfer Mode (ATM), and other network technologies configured to transport Internet Protocol (IP) packets.

The system (308) may be coupled to the one or more first computing devices (304) through the communication network (306). In some implementations, the system (308) may be operatively coupled to the plurality of uplink communication channels and the downlink communication channels associated with the communication network (306). The heterogenous computing system (308) may be further equipped with a RE mapper.

In an embodiment, the system (308) may be configured to efficiently design the RE mapper. The system (308) may pre-process one or more L1 parameters of a plurality of downlink (DL) or uplink (UL) protocol data units (PDUs) received from a Medium Access Control (MAC) to Physical (PHY) interface in a PS. The one or more parameters of the PDUs may include, but not limited to, mapping parameters such as a start physical resource block (PRB), a number of PRBs, a start symbol, and a number of symbols, and other mapping parameters such as a Demodulation Reference Signal (DMRS) type, a number of layers, and a Code-Division Multiplexing (CDM) type.

In an embodiment, the system (308) may generate one or more required bits of control information per PRB instead of per RE. The system (308) may further arrange per PRB control information in the form of a grid and transfer the generated control information from the PS to a programmable logic (PL), for example, a FPGA using a direct memory access (DMA).

In an embodiment, the system (308) may be configured to set the bit width of slot indices to at least 16 to store crucial grid mapping information per PRB per symbol in an intelligent way such that mapping onto slot grid may be done straightforwardly without any additional need of processing by the PL RE mapping block which saves FPGA resources. Storing of the control information per PRB instead of per RE significantly saves memory consumption which in turn reduces time and memory constraints for DMA transfer and the same may be consumed by the RE mapper in slot N.

Although FIG. 3 shows exemplary components of the network architecture (300), in other embodiments, the network architecture (300) may include fewer components, different components, differently arranged components, or additional functional components than depicted in FIG. 3. Additionally, or alternatively, one or more components of the network architecture (300) may perform functions described as being performed by one or more other components of the network architecture (300).

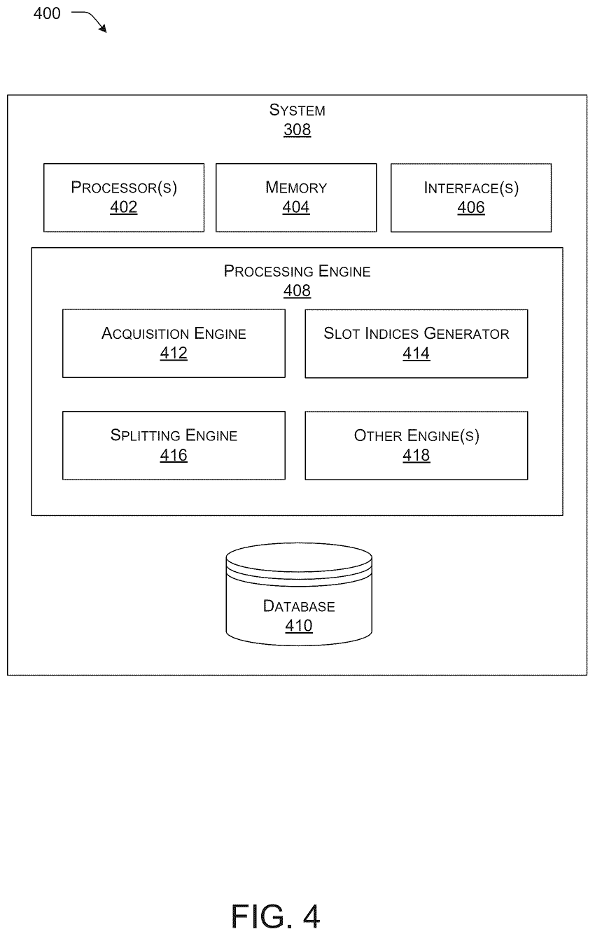

FIG. 4 illustrates an exemplary block diagram (400) of the system (308), in accordance with an embodiment of the present disclosure.

With respect to FIG. 4, the system (308) may include one or more processor(s) (402) coupled with a memory (404). The memory (404) may store instructions which when executed by the one or more processors (402) may cause the system (308) to perform the steps as described herein. The processor (402) may be configured to receive a plurality of downlink or uplink PDUs from MAC over FAPI interface in the PS, for example, an Advanced Reduced Instruction Set Computer (RISC) Machine (ARM) core. The processor (402) may be configured to process a plurality of L1 parameters of the plurality of downlink PDUs and the plurality of uplink PDUs. The processor (402) may be configured to generate one or more required bits of control information per PRB based on the plurality of L1 parameters. The processor (402) may be configured to arrange the one or more required bits of control information per PRB in the form of a grid. Further, the processor (402) may be configured to transfer one or more required bits of control information per PRB from the ARM core to the programmable logic, for example, FPGA using the DMA.

The one or more processor(s) (402) may be implemented as one or more ARM core processors, microprocessors, microcomputers, microcontrollers, digital signal processors, central processing units, logic circuitries, and/or any devices that process data based on operational instructions. Among other capabilities, the one or more processor(s) (402) may be configured to fetch and execute computer-readable instructions stored in the memory (404) of the system (308). The memory (404) may be configured to store one or more computer-readable instructions or routines in a non-transitory computer readable storage medium, which may be fetched and executed to create or share data packets over a network service. The memory (404) may comprise any non-transitory storage device including, for example, volatile memory such as Random Access Memory (RAM), or non-volatile memory such as Erasable Programmable Read-Only Memory (EPROM), flash memory, and the like.

In an embodiment, the system (308) may include an interface(s) (406). The interface(s) (406) may comprise a variety of interfaces, for example, interfaces for data input and output devices, referred to as I/O devices, storage devices, and the like. The interface(s) (406) may facilitate communication of the system (308). The interface(s) (406) may also provide a communication pathway for one or more components of the system (308). Examples of such components include, but are not limited to, processing engine(s) (408) and a database (410).

The processing engine(s) (408) may be implemented as a combination of hardware and programming (for example, programmable instructions) to implement one or more functionalities of the processing engine(s) (408). In examples described herein, such combinations of hardware and programming may be implemented in several different ways. For example, the programming for the processing engine(s) (408) may be processor-executable instructions stored on a non-transitory machine-readable storage medium, and the hardware for the processing engine(s) (408) may comprise a processing resource (for example, one or more processors), to execute such instructions. In the present examples, the machine-readable storage medium may store instructions that, when executed by the processing resource, implement the processing engine(s) (408). In such examples, the system (308) may comprise the machine-readable storage medium storing the instructions and the processing resource to execute the instructions, or the machine-readable storage medium may be separate but accessible to the system (308) and the processing resource. In other examples, the processing engine(s) (408) may be implemented by electronic circuitry.

The processing engine (408) may include one or more components as shown in FIG. 4. The one or more components may include an acquisition engine (412), a slot indices generator (414), a splitting engine (416), and other engines (418). The acquisition engine (412) may be configured to receive a plurality of downlink or uplink PDUs from MAC to PHY interface in an ARM core.

The slot indices generator (414) may be configured to process a plurality of L1 parameters of the plurality of downlink PDUs and the plurality of uplink PDUs. The slot indices generator (414) may be configured to generate one or more required bits of control information per PRB based on the plurality of L1 parameters. Further, the slot indices generator (414) may be configured to arrange the one or more required bits of control information per PRB in the form of a grid.

The slot indices generator (414) may be associated with the PS or a processor core of the re mapper. The slot indices generator (414) may take the one or more L1 parameters of the plurality of DL or UL PDUs and generate control grid information such as slot indices which are required for data mapping onto the grid.

In an embodiment, the slot indices generator (414) may be configured to absorb control parameters, mapping parameters, and allocation parameters for the DL chain such as the SSB, the PDCCH, the PDSCH, and the CSI-RS. The slot indices generator (414) may be configured to process the control parameters, the mapping parameters, and the allocation parameters for the DL chain such as the SSB, the PDCCH, the PDSCH, and the CSI-RS. The slot indices generator (414) may be configured to make a crux of the control parameters, the mapping parameters, and the allocation parameters for the DL chain such as the SSB, the PDCCH, the PDSCH, and the CSI-RS. The slot indices generator (414) may finally prepare a compact output vector such as a slot indices grid for mapping various PDUs data onto the slot grid. A total memory required for storing the control parameters in each of the slot may be given by Number of RBs*Number of Symbols per Slot*Bit-width/bits per Byte=273*14*16/8=7644 Bytes (7.465 KB).

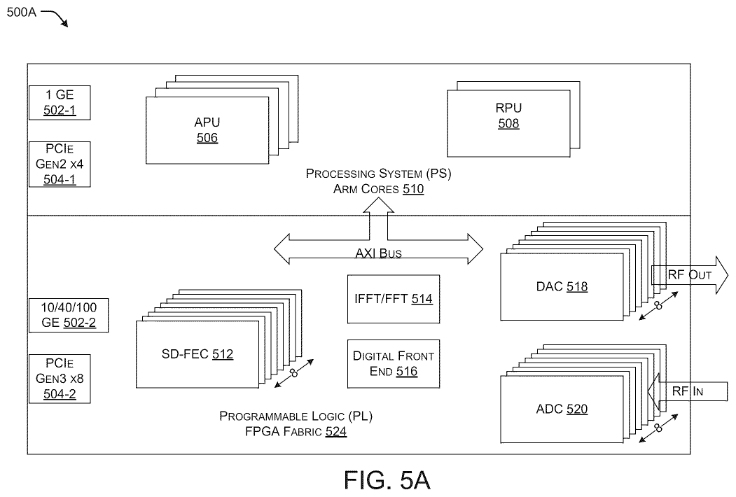

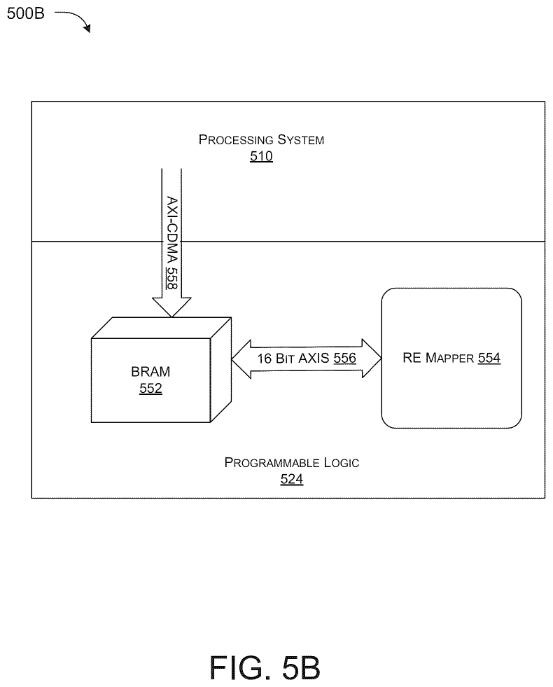

The splitting engine (416) may be configured to transfer the one or more required bits of control information per PRB from the PS (510) to the PL (524) (as shown in FIG. 5A) using DMA.

Although FIG. 4 shows exemplary components of the system (308), in other embodiments, the system (308) may include fewer components, different components, differently arranged components, or additional functional components than depicted in FIG. 4. Additionally, or alternatively, one or more components of the system (308) may perform functions described as being performed by one or more other components of the system (308).

FIG. 5A illustrates an exemplary architecture (500A) of a radio frequency system on chip (RFSoC), in accordance with an embodiment of the present disclosure.

In a heterogeneous computing system (308) such as the RFSOC, the heterogeneous computing system (308) may have two major components, namely a PS (510) and a PL (524). An ARM core which may be termed as the PS (510) may have the following resources:
Accelerated Processing Unit (APU), for example, four 64-bit ARM Cortex-A53 cores (506) and a Redundant Array of Independent Disks (RAID) processing unit (RPU), for example, two ARM Cortex-R5 cores (508) which may form:
the FPGA Fabric which may be termed as the PL (524) with the following limited resources
   a. 930K System Logic Cells
   b. 850K CLB Flip-Flops
   c. 425K CLB LUTS
   d. 4K DSP Slices
   e. 38 Mb Block RAM, 22 Mb Ultra RAM.

The ARM cores (PS) may perform configuration reception, parsing, and pre-processing, and remaining tasks like, data processing and RE mapping may be handled in the FPGA (PL).

FIG. 5B illustrates an exemplary representation (500B) of a RE mapper for implementing control parameter buffer transfer mechanism from the PS (510) to the PL (524) in a heterogeneous computing system (308), in accordance with an embodiment of the present disclosure.

With respect to FIG. 5B, the PL (524) may include a Block Random Access Memory (BRAM) (552) and the RE mapper (554) connected with the BRAM (552) by a 16-bit AXIS (556). The PS (510) may generate slot indices and the generated slot indices may be transferred from the PS (510) to the PL (524) using, but not limited to, an Advanced Extensible Interface Code-Division Multiple Access (AXI-CDMA) (558) as shown in FIG. 5B. This ensures an efficient way of handling complex block design by processing split (offloading task 4a to ARM) and performing handshake between the PS (510) and the PL (524), thus reducing the usage of FPGA resources and processing cycles.

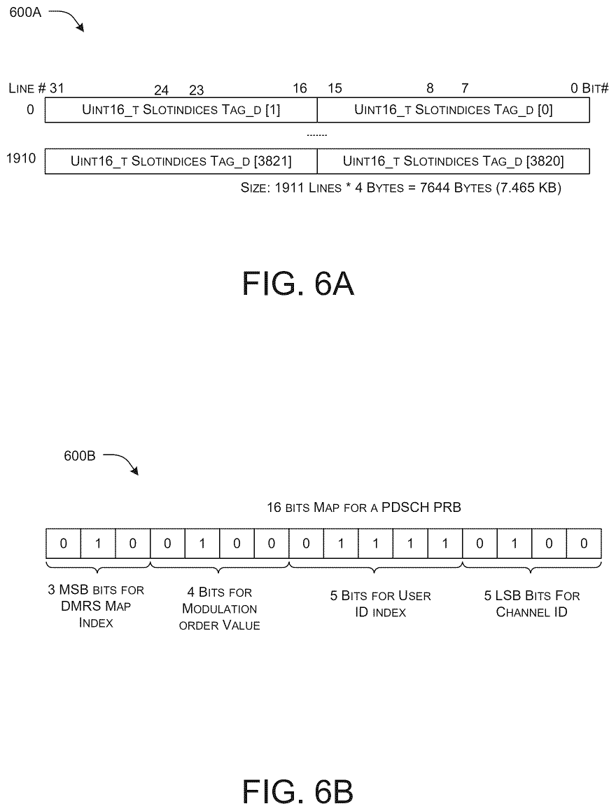

FIG. 6A illustrates an exemplary representation (600A) of an RE mapper control parameters buffer, and FIG. 6B illustrates an exemplary representation (600B) of 16 bits map for a PDSCH PRB, in accordance with embodiments of the present disclosure.

With respect to FIG. 6A, an Application Programming Interface (API), for example, a slot indices generator may be created in ARM core which takes L1 parameters of all physical channel PDUs and generates control grid information (the slot indices) which are required for data mapping onto the grid. The API may absorb the control/mapping/allocation parameters for each DL chain like SSB, PDCCH, PDSCH and CSI-RS, process the parameters, and make a crux of the parameters. The API may finally prepare a compact output vector (the slot indices grid) as shown in FIG. 6A, for mapping of various PDUs data onto slot grid. The total memory required for storing the control parameters per slot=Number of RBs*Number of Symbols per Slot*Bit-width/bits per Byte=273*14*16/8=7644 Bytes (7.465 KB).

Table 1 below shows a bit width of the slot indices that may be set to 16 to store crucial grid mapping information per PRB per symbol in an intelligent way such that mapping in PL may be done straightforwardly without any additional need for processing which saves the FPGA resources. Storing of control information per PRB instead of per RE may significantly save memory consumption which in turn may reduce time and memory constraints for the DMA transfer and the same may be consumed by the RE mapper in slot N as shown in Table 1 below.

TABLE 1

| S. No | Storage Unit | Bit width | Memory required by one slot Tag Grid |
|---|---|---|---|
| 1 | RE | 8 | 366912 (14 × 273 × 12 × 8) |
| 2 | PRB | 16 | 61152 (14 × 273 × 16) |

The handshake of 16 bit per PRB per symbol information is described below:

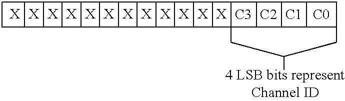

4 LSB bits may be used for defining various channels/chains which occupy the concerned PRB. The values for this field may be as follows:
1˜ SSB Block PRB
2˜ PDCCH Chain data PRB
3˜ PDSCH Data only PRB
4˜ PDSCH and DMRS Data PRB
5˜ PDSCH DMRS only PRB
6˜ CSIRS Data only PRB
7˜ PDSCH Data & CSIRS Data PRB
8-15˜ Reserved for future purpose

The usage of remaining bits may be defined as per corresponding chain requirements. For example, for a PDSCH allocation, the remaining 12 bits usage per PRB per symbol may be defined as shown in FIG. 6B. The next 5 bits after 4 LSB bits may be designated as user index bits. In FIG. 6B, the value 16 may designate the 16th user. This field may be valid for channel IDs 2 to 7. Immediate next 4 bits may be designated to modulation order of the PDSCH PDU with possible values of 2, 4, 6, 8 representing Quadrature Phase Shift Keying (QPSK), 16 Quadrature Amplitude Modulation (QAM), 64 QAM, and 256 QAM, respectively. This field may be valid for channel IDs 3, 4, 5, 7 only. Last 3 bits or 3 MSB bits may be designated to the DMRS map index of PDSCH DMRS PRB. The value may be defined by taking into consideration below parameters of the PDSCH PDU:
DMRS Type
Number of Layers
CDM Group

Value 2 may represent DMRS type as 1, number of layers as 1, and CDM type as 1. Various combination of above mentioned 3 parameters may be defined with value ranging from 0 to 7 and filled in the DMRS map index. This field may be valid for channel IDs 4 and 5.

In an embodiment, for a CSIRS channel tag creation, every field may be same as that of the PDSCH except that the DMRS map index, which may be replaced with a user index of a CSIRS PDU index. In this case, the user indexes of the PDSCH may not be replaced for the CSI-RS as both the PDUs may occur in same PRB of same symbol.

For SSB block, the tag generation may have slightly different fields. As explained in previous sections, the SSB block may occupy 4 continuous time domain symbols and 20 or 21 PRBs in each symbol. There may be 1, 2, or no SSB blocks in a slot. Various symbols may consist of different types of data and hence tag generation per PRB may need to handle the various combinations as follows:
1˜ Zeros only
2˜ PSS/SSS only
3˜ PBCH only
4˜ Zeros and PSS/SSS
5˜ Zeros and PBCH
6˜ Zeros, PSS/SSS and PBCH

This tag for each PRB of the SSB block may address each of all possible combinations of SSB mapping defined by 3GPP. Thus, tag generation algorithm per PRB per symbol may give the benefit of reduced control information transfer to FPGA module compared to per RE per symbol. This may result in simplified DMA transfer and also reduced memory requirement at the FPGA for storing control information. The generated slot tag vector may then be transferred to FPGA processing block. The tags may be used by the mapping block to determine which data channel may be mapped onto each PRB. The FPGA mapping block may have the data of each DL channel (SSB, PDCCH, PDSCH, PDCCH, and CSIRS) and the value from the slot tag vector may derive the mapping of these data channels onto the applicable PRB.

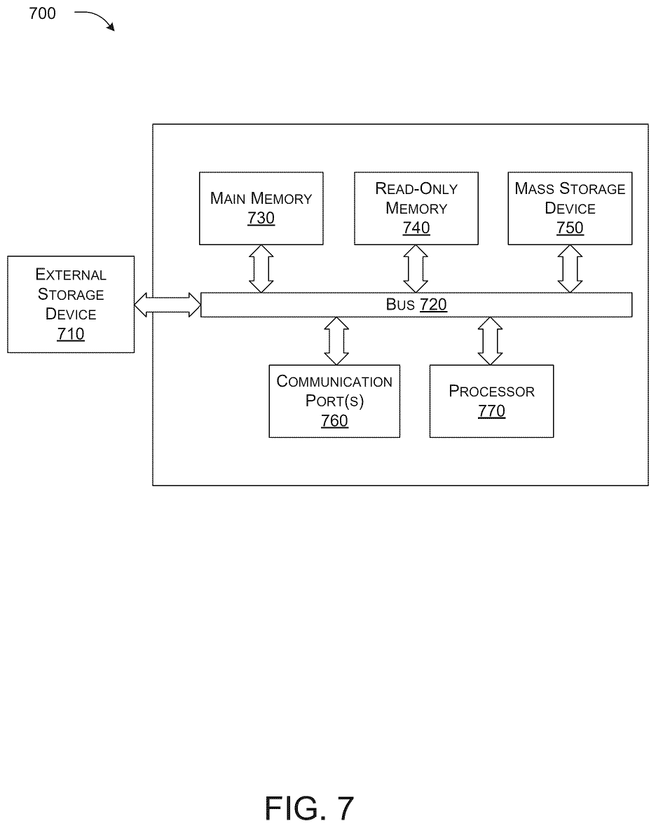

FIG. 7 illustrates an exemplary computer system (700) in which or with which embodiments of the present disclosure may be implemented.

As shown in FIG. 7, the computer system (700) may include an external storage device (710), a bus (720), a main memory (730), a read only memory (740), a mass storage device (750), a communication port (760), and a processor (770). A person skilled in the art will appreciate that the computer system (700) may include more than one processor and communication ports. The processor (770) may include various modules associated with embodiments of the present disclosure. The communication port (760) may be any of an RS-232 port for use with a modem-based dialup connection, a 10/100 Ethernet port, a Gigabit or 10 Gigabit port using copper or fibre, a serial port, a parallel port, or other existing or future ports. The communication port (760) may be chosen depending on a network, such a Local Area Network (LAN), Wide Area Network (WAN), or any network to which computer system (700) connects.

The memory (730) may be a Random Access Memory (RAM), or any other dynamic storage device commonly known in the art. The read-only memory (740) may be any static storage device(s) e.g., but not limited to, a Programmable Read Only Memory (PROM) chips for storing static information e.g., start-up or Basic INPUT/Output System (BIOS) instructions for the processor (770). The mass storage (750) may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

The bus (720) communicatively couples the processor(s) (770) with the other memory, storage, and communication blocks. The bus (720) may be, e.g., a Peripheral Component Interconnect (PCI)/PCI Extended (PCI-X) bus, Small Computer System Interface (SCSI), USB, or the like, for connecting expansion cards, drives and other subsystems as well as other buses, such a front side bus (FSB), which connects the processor (770) to the computer system (700).

Optionally, operator and administrative interfaces, e.g., a display, keyboard, and a cursor control device, may also be coupled to the bus (720) to support direct operator interaction with the computer system (700). Other operator and administrative interfaces may be provided through network connections connected through the communication port (760). The external storage device (710) may be any kind of external hard-drives, floppy drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system (700) limit the scope of the present disclosure.

Thus, the present disclosure provides a technical solution for facilitating an effective reduction in RE mapper design complexity and leads to significant saving of FPGA resources and processing time. The proposed method may be applied to both DL and UL in any OFDM based technology and the bit width of control information may be further optimized as per the requirements of the system (308). Several other advantages may be realized.

It would be appreciated that the embodiments herein are explained with respect to the system (308), however, the proposed system (308) and method may be implemented in any computing device or external devices without departing from the scope of the disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Invention

The present disclosure provides a system and a method for handling complex RE mapping block by a processing split and performing handshake between a processing system and a programmable logic in an efficient manner, thus reducing the usage of programmable logic (PL) resources and processing cycles.

The present disclosure provides a system and a method to facilitate an efficient utilization of a plurality of core processors and programmable logic (PL) resources.

The present disclosure provides a system and a method to reduce Direct Memory Access (DMA) transfer time and memory with Physical resource block (PRB) wise design.

The present disclosure provides a system and a method to facilitate the reduction of requirement of PL resources and processing latency for Resource Element (RE) mapper.

We claim:

1. A system (308) for controlling overhead and functional split of a Resource Element (RE) mapper, the system (308) comprising:
one or more processors (402); and
a memory (404) operatively coupled to the one or more processors (402), wherein the memory (404) comprises processor-executable instructions, which on execution, cause the one or more processors (402) to:
receive a plurality of physical channel Protocol Data Units (PDUs) comprising one or more parameters;
pre-process the one or more parameters of the plurality of physical channel PDUs;
generate one or more bits of control information per Physical Resource Block (PRB) based on the pre-processed one or more parameters;
arrange the generated one or more bits of control information per PRB in a grid; and
transfer the grid comprising the generated one or more bits of control information per PRB from a processing system (510) to a programmable logic (524) of the system (308) using a Direct Memory Access (DMA).

2. The system (308) as claimed in claim 1, wherein the one or more processors (402) are to process the one or more parameters of the plurality of physical channel PDUs which comprise at least one of: Synchronization Signal Block (SSB), Physical Downlink Control Channel (PDCCH), Physical Downlink Shared Channel (PDSCH), and Channel State Information Reference Signal (CSI-RS).

3. The system (308) as claimed in claim 1, wherein the one or more processors (402) are to arrange the generated one or more bits of control information per PRB in the grid by being configured to:
process the generated one or more bits of control information per PRB; and
form the grid based on the generated one or more bits of control information per PRB.

4. The system (308) as claimed in claim 1, wherein a bit width of the one or more bits of control information is variable, further wherein the bit width is 16.

5. The system (308) as claimed in claim 1, wherein the one or more processors (402) are to transfer the grid to the programmable logic using an Advanced Extensible Interface Code-Division Multiple Access (AXI-CDMA).

6. A method for controlling overhead and functional split of a Resource Element (RE) mapper, the method comprising:
receiving, by a processor (402) associated with a system (308), a plurality of physical channel Protocol Data Units (PDUs) comprising one or more parameters;
pre-processing, by the processor (402), the one or more parameters of the plurality of physical channel PDUs;
generating, by the processor (402), one or more bits of control information per Physical Resource Block (PRB) based on the pre-processed one or more parameters;
arranging, by the processor (402), the generated one or more bits of control information per PRB in a grid; and
transferring, by the processor (402), the grid comprising the generated one or more bits of control information per PRB from a processing system to a programmable logic of the system (308) using a Direct Memory Access (DMA).

7. The method as claimed in claim 6, comprising processing, by the processor (402), one or more parameters of the plurality of physical channel PDUs which are at least one of: Synchronization Signal Block (SSB), Physical Downlink Control Channel (PDCCH), Physical Downlink Shared Channel (PDSCH), and Channel State Information Reference Signal (CSI-RS).

8. The method as claimed in claim 6, wherein arranging, by the processor (402), the generated one or more bits of control information per PRB in the grid comprises:
processing, by the processor (402), the generated one or more bits of control information per PRB; and
forming, by the processor (402), the grid based on the generated one or more bits of control information per PRB.

9. The method as claimed in claim 6, wherein a bit width of the one or more bits of control information is variable, further wherein the bit width is 16.

10. The method as claimed in claim 6, wherein the transferring comprises transferring, by the processor (402), the grid to the programmable logic using an Advanced Extensible Interface Code-Division Multiple Access (AXI-CDMA).

11. A non-transitory computer-readable medium comprising processor-executable instructions that cause a processor to:
receive a plurality of physical channel Protocol Data Units (PDUs) comprising one or more parameters;
pre-process the one or more parameters of the plurality of physical channel PDUs;
generate one or more bits of control information per Physical Resource Block (PRB) based on the pre-processed one or more parameters;
arrange the generated one or more bits of control information per PRB in a grid; and
transfer the grid comprising the generated one or more bits of control information per PRB from a processing system to a programmable logic using a Direct Memory Access (DMA).
